(19) United States
(12) Patent Application Publication
(10) Pub. No.: US 2008/0025519 A1
(43) Pub. Date: Jan. 31, 2008

(54) Binaural rendering using subband filters

(76) Inventors: Rongshan Yu, San Francisco, CA (US); Charles Quito Robinson, San Francisco, CA (US); Mark Stuart Vinton, San Francisco, CA (US)

Correspondence Address: GALLAGHER & LATHROP, A PROFESSIONAL CORPORATION, 601 CALIFORNIA ST, SUITE 1111, SAN FRANCISCO, CA, 94108, US

(21) Appl. No.: 11/881,435

(22) Filed: Jul. 27, 2007

Related U.S. Application Data
(63) Continuation of application No. PCT/US07/06522, filed on Mar. 14, 2007.
(60) Provisional application No. 60/782,967, filed on Mar. 15, 2006.

(51) Int. Cl. H04R 5/00

(52) U.S. Cl. 381/17

(57) ABSTRACT

Transfer functions like Head Related Transfer Functions (HRTF) needed for binaural rendering are implemented efficiently by a subband-domain filter structure. In one implementation, amplitude, fractional-sample delay and phase-correction filters are arranged in cascade with one another and applied to subband signals that represent spectral content of an audio signal in frequency subbands. Other filter structures are also disclosed. These filter structures may be used advantageously in a variety of signal processing applications. A few examples of audio applications include signal bandwidth compression, loudness equalization, room acoustics correction and assisted listening for individuals with hearing impairments.

### TECHNICAL FIELD

The present invention pertains generally to signal processing and pertains more particularly to signal processes that provide accurate and efficient implementations of transfer functions.

### BACKGROUND ART

Typical signal processing techniques that are used to implement transfer functions often use computationally intensive high-order filters. Binaural rendering is one example of an application that typically employs transfer functions to synthesize the aural effect of many audio sources in a sound field using only two audio channels. Binaural rendering generates a two-channel output signal with spatial cues derived from one or more input signals, where each input signal has associated with it a position that is specified relative to a listener location. The resulting binaural output signal, when played back over appropriate devices such as headphones or loudspeakers, is intended to convey the same aural image of a soundfield that is created by the input acoustic signals originating from the one or more specified positions.

The exact path and the physical features encountered along the path from an acoustic source to an ear or other sensor will result in particular sound modifications. For example, environmental or architectural features such as large open spaces or reflective surfaces affect the acoustic waves and impart a variety of characteristics such as reverberation. In this disclosure, more particular mention is made of acoustic features and effects on acoustic waves that arrive at the ears of a human listener.

An acoustic wave generated by an acoustic source follows different acoustic paths to each ear of a listener, which generally causes different modifications. The location of the ears and shape of the outer ear, head, and shoulders cause acoustic waves to arrive at each ear at different times with different acoustic levels and different spectral shapes. The cumulative effect of these modifications is called a Head Related Transfer Function (HRTF). The HRTF varies with individual and also varies with changes in the position of the sound source relative to the location of the listener. A human listener is able to process the acoustic signals for both ears as modified by the HRTF to determine spatial characteristics of the acoustic source such as direction, distance and the spatial width of the source.

The binaural rendering process typically involves applying a pair of filters to each input signal to simulate the effects of the HRTF for that signal. Each filter implements the HRTF for one of the ears in the human auditory system. All of the signals generated by applying a left-ear HRTF to the input signals are combined to generate the left channel of the binaural signal and all of the signals generated by applying a right-ear HRTF to the input signals are combined to generate the right channel of the binaural signal.

Two-channel signals are available from a variety of sources such as radio and audio compact discs for reproduction over loudspeakers or headphones; however, many of these signals convey very few binaural cues. The reproduction of such signals conveys few if any spatial impressions. This limitation is especially noticeable in playback over headphones, which can create “inside the head” aural images. If a two-channel signal conveys sufficient binaural cues, which is referred to herein as a binaural signal, the reproduction of that signal can create listening experiences that include strong spatial impressions.

One application for binaural rendering is to improve the listening experience with multi-channel audio programs that are reproduced by only two audio channels. A high-quality reproduction of multi-channel audio programs such as those associated with video programs on DVDs and HDTV broadcasts typically requires a suitable listening area with multiple channels of amplification and loudspeakers. In general, spatial perception of a two-channel reproduction is greatly inferior unless binaural rendering is used.

In a typical implementation of binaural rendering for a system with five input channels, for example, the binaural output signal is obtained by applying two full-bandwidth filters to each input signal, one filter for each output channel, and combining the filter outputs for each output channel. The filters are typically finite impulse response (FIR) digital filters, which can be implemented by convolving an appropriate discrete-time impulse response with an input signal. The length of the impulse response used to represent an HRTF directly affects the computational complexity of the processing required to implement the filter. Techniques such as fast convolution techniques are known that can be used to reduce the computational complexity yet maintain the accuracy with which the filter simulates a desired HRTF; however, there is a need for techniques that can implement high-quality simulations of transfer functions with even greater reductions in computational complexity.

### DISCLOSURE OF INVENTION

It is an object of the present invention to provide for efficient implementations of filters that implement transfer functions.

According to one aspect of the present invention, a subband-domain filter structure implements HRTF for use in a variety of applications including binaural rendering. In one implementation, the filter structure comprises an amplitude filter, a fractional-sample delay filter and a phase-correction filter arranged in cascade with one another. Different but equivalent structures exist.

According to other aspects of the present invention, a subband-domain filter structure is used for a variety of applications including loudness equalization in which the loudness of a signal is adjusted on a subband-by-subband basis, room acoustics correction in which a signal is equalized on a subband-by-subband basis according to acoustic properties of the room where the signal is played back, and assisted listening in which a signal is equalized on a subband-by-subband basis according to a listener's hearing impairment.

The present invention may be used advantageously with processing methods and systems that generate any number of channels of output signals.

The processing techniques performed by implementations of the present invention can be combined with other coding techniques such as Advanced Audio Coding (AAC) and surround-channel signal coding (MPEG Surround). The subband-domain filter structure can be used to reduce the overall computational complexity of the system in which it is used by rearranging and combining components of the structure to eliminate redundant filtering among subbands or multiple channels.

The various features of the present invention and its preferred embodiments may be better understood by referring to the following discussion and the accompanying drawings. The contents of the following discussion and the drawings are set forth as examples only and should not be understood to represent limitations upon the scope of the present invention.

### BRIEF DESCRIPTION OF DRAWINGS

FIGS. 1a and 1b are schematic block diagrams of an encoder and a decoder in an audio coding system.

FIGS. 2 and 3 are schematic block diagrams of audio decoders that binaurally render five channels of audio information.

FIG. 4 is a graphical illustration of the amplitude and phase responses of an HRTF.

FIG. 5 is a schematic block diagram of a subband-domain filter structure coupled to the input of a synthesis filterbank.

FIG. 6 is a schematic block diagram of a subband filter.

FIG. 7 is a schematic block diagram of an audio encoding system that incorporates a subband-domain filter structure.

FIG. 8 is a schematic block diagram of a subband-domain filter structure and a corresponding time-domain filter structure.

FIG. 9 is a schematic block diagram that illustrates the noble identities for a multirate filter system.

FIGS. 10 and 11 are schematic diagrams of the responses of subband filters.

FIGS. 12a and 12b are graphical illustrations of the group delays of subband delay filters.

FIG. 13 is a schematic block diagram of a component in spatial audio decoder.

FIGS. 14 and 15 are schematic block diagrams of a component of a spatial audio decoder coupled to filter structures that implement binaural rendering.

FIGS. 16 and 17 are schematic block diagrams of filter structures that combine common component filters to reduce computational complexity.

FIG. 18 is a schematic block diagram of a device that may be used to implement various aspects of the present invention.

### MODES FOR CARRYING OUT THE INVENTION

### A. Introduction

The present invention may be used advantageously in a variety of applications including audio compression or audio coding. Audio coding is used to reduce the amount of space or bandwidth required to store or transmit audio information. Some perceptual audio coding techniques split audio signals into subband signals and encode the subband signals in a way that attempts to preserve the perceived or subjective quality of audio signals. Some of these techniques are known as Dolby Digital™, Dolby TrueHD™, MPEG 1 Layer 3 (mp3), MPEG 4 Advanced Audio Coding (AAC) and High Efficiency AAC (HE-AAC).

Other coding techniques can be used independently or in combination with the perceptual coding techniques mentioned above. One technique referred to as Spatial Audio Coding (SAC) can be used to compress multiple audio channels by combining or down-mixing individual input signals into a composite signal in such a way that a replica of the original input signals can be recovered by up-mixing the composite signal. If desired, this type of processing can generate “side information” or “metadata” to help control the up-mixing process. Typically the composite signal has one or two channels and is generated in such a way that it can be played back directly to provide an acceptable listening experience though it may lack a full spatial impression. Examples of this process include techniques known as Dolby ProLogic and ProLogic2. These particular methods do not use metadata but use phase relationships between channels that are detected during the encode/down-mix process. Other techniques generate metadata parameters during the encode/down-mix process, which are used during the up-mixing process as described above. Typical metadata parameters include channel level differences (CLD), inter-channel time differences (ITD) or inter-channel phase differences (IPD), and inter-channel coherence (ICC). The metadata parameters are typically estimated for multiple subbands across all input channel signals.

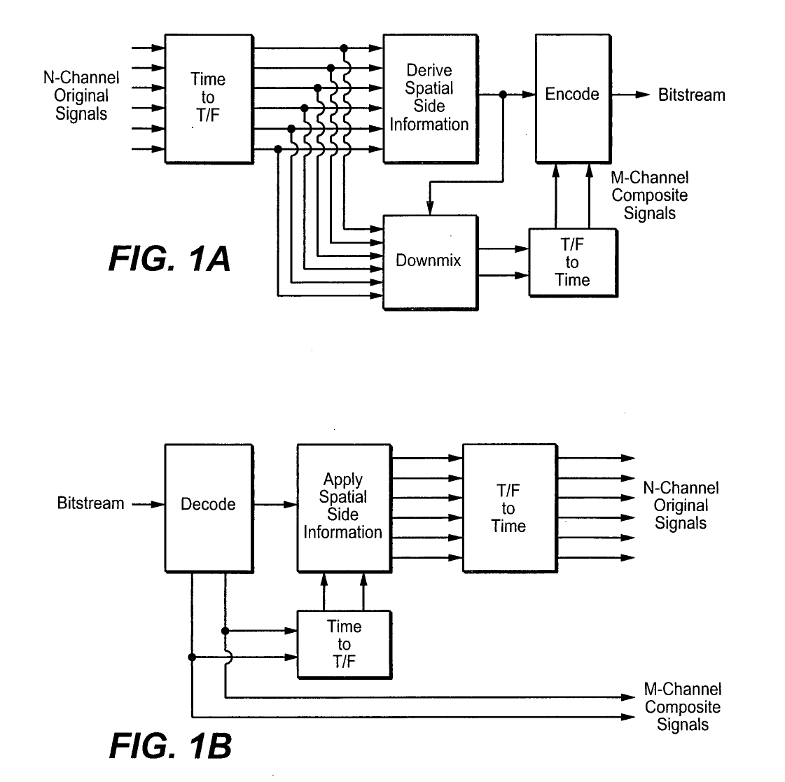

An encoder and a decoder for a spatial coding system are shown in FIGS. 1a and 1b, respectively. The encoder splits an N-channel input signal into subband signals in the Time/Frequency (T/F) domain utilizing an appropriate analysis filterbank implemented by any of a variety of techniques such as the Discrete Fourier Transform (DFT), the Modified Discrete Cosine Transform (MDCT) or a set of Quadrature Mirror Filters (QMF). An estimate of the CLD, ITD, IPD and/or ICC is computed as side information or metadata for each of the subbands. If an M-channel composite signal that corresponds to the N-channel input signal does not already exist, this side information may be used to down-mix the original N-channel input signal into the M-channel composite signal. Alternatively, an existing M-channel composite signal may be processed simultaneously with the same filterbank and the side information of the N-channel input signal can be computed relative to that for the M-channel composite signal. The side information and the composite signal are encoded and assembled into an encoded output signal. The decoder obtains from the encoded signal the M-channel composite signal and the side information. The composite signal is transformed to the T/F domain and the side information is used to up-mix the composite signal into corresponding subband signals to generate an N-channel T/F domain signal. An appropriate synthesis filterbank is applied to the N-channel T/F domain signal to recover an estimate of the original N-channel time-domain signal. Alternatively, the up-mixing process may be omitted and the M-channel composite signal is played back instead.

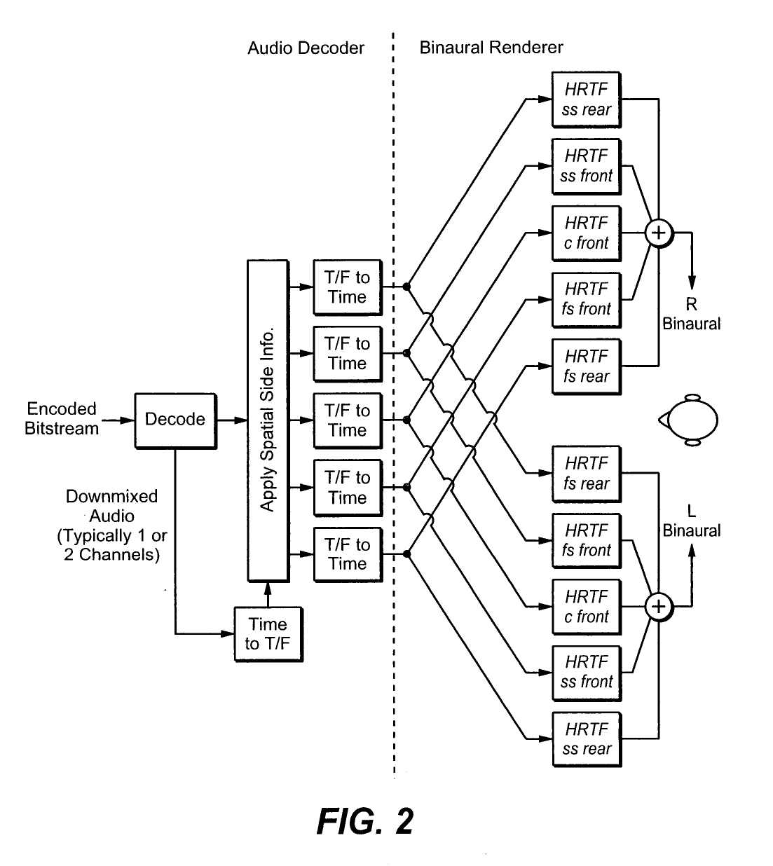

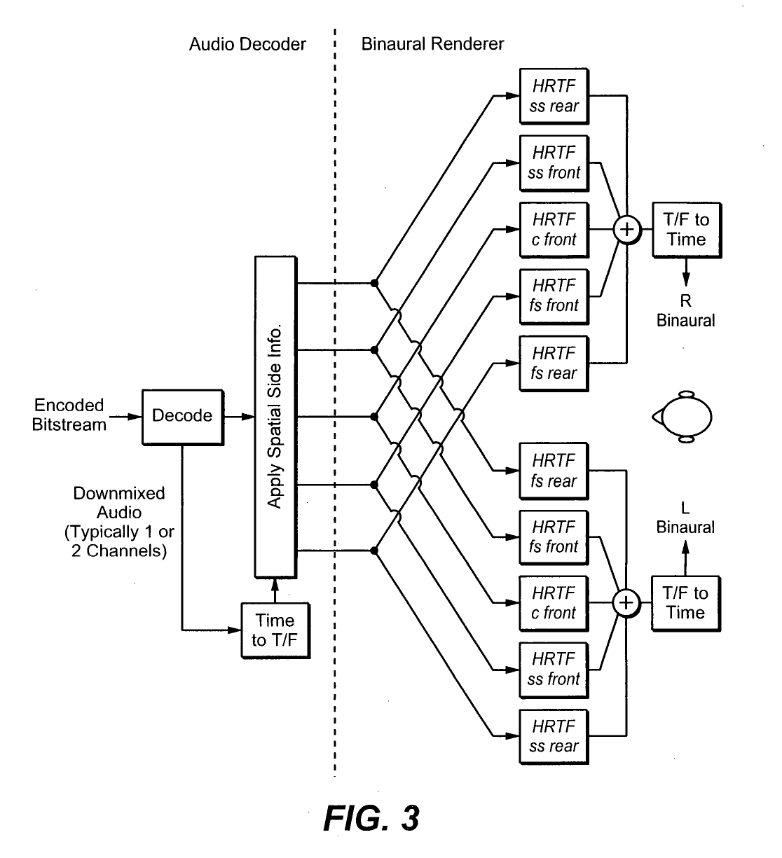

FIG. 2 illustrates a conventional coding system in which five output channels of decoded audio signals are to be rendered binaurally. In this system, each output channel signal is generated by a respective synthesis filterbank. Filters implementing left-ear and right-ear HRTF are applied to each output channel signal and the filter output signals are combined to generate the two-channel binaural signal. Alternatively, as shown in FIG. 3, pairs of filters implementing the HRTF can be applied to the T/F domain signals to generate pairs of filtered signals, combined in pairs to generate left-ear and right-ear T/F domain signals, and subsequently converted into time-domain signals by respective synthesis filterbanks. This alternative implementation is attractive because it can often reduce the number of synthesis filters, which are computationally intensive and require considerable computational resources to implement.

The filters used to implement the HRTF in conventional systems like those shown in FIGS. 2 and 3 are typically computationally intensive because the HRTF have many fine spectral details. A response of a typical HRTF is shown in FIG. 4. An accurate implementation of the fine detail in the amplitude response requires high-order filters, which are computationally intensive. A subband-domain filter structure according to the present invention is able to accurately implement HRTF without requiring high-order filters.

### B. Subband-Domain Filter Structure

### 1. Overview

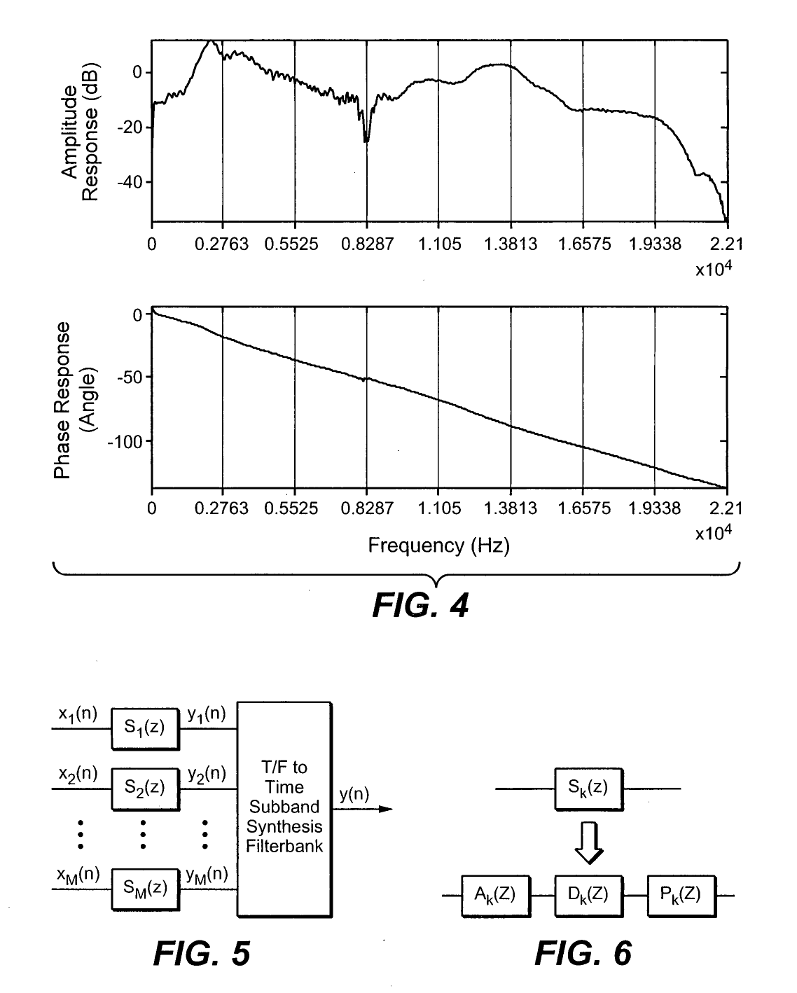

A subband-domain filter structure is shown schematically in FIG. 5. Each subband signal xₖ(n) is processed by a filter Sₖ(z) that implements an approximation of a portion of an HRTF that corresponds to the subband. In one implementation shown in FIG. 6, each subband filter Sₖ(z) comprises a cascade of three filters. The filter Aₖ(z) alters the amplitude of the subband signal. The filter Dₖ(z) alters the group delay of the subband signal by an amount that includes a fraction of one sample period, which is referred to herein as a fractional-sample delay. The filter Pₖ(z) alters the phase of the subband signal.

The amplitude filter Aₖ(z) is designed to ensure the composite amplitude response of the subband-domain filter structure is equal or approximately equal to the amplitude response of the target HRTF within a particular subband.

For at least some of the subbands, the delay filter Dₖ(Z) is a fractional-sample delay filter that is designed to model accurately the delay of the target HRTF for signal components in a particular subband. Preferably, the delay filter provides a constant fractional-sample delay over the entire frequency range of the subband.

The phase filter Pₖ(Z) is designed to provide a continuous phase response with the response of the phase filter for an adjacent subband to avoid undesirable signal cancellation effects when the subband signal are synthesized at the synthesis filter.

These filters are described below in more detail.

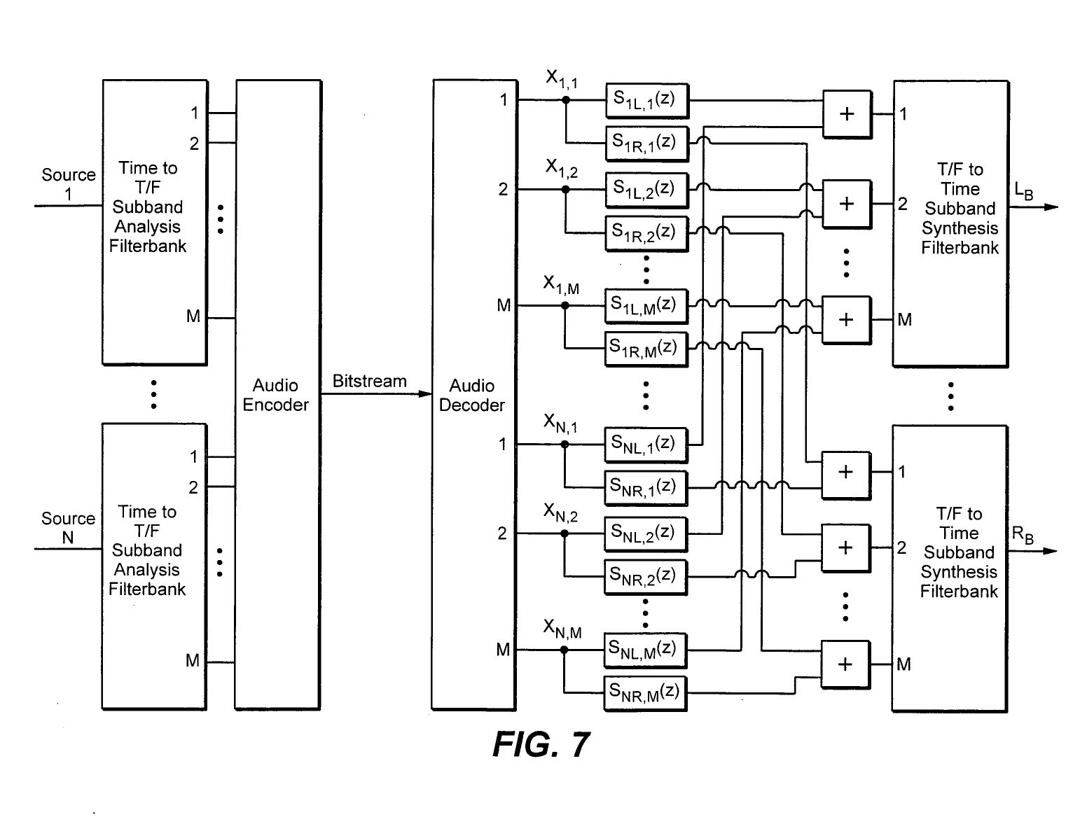

FIG. 7 is a schematic illustration of an audio coding system with an N-channel input and a two-channel output that incorporates the subband-domain filter structure of the present invention. Each input channel signal is split into subband signals by an analysis filterbank and encoded. The encoded subband signals are assembled into an encoded signal or bitstream. The encoded signal is subsequently decoded into subband signals. Each decoded subband signal is processed by the appropriate subband-domain filter structures, where the notations S_{nL,m}(z) and S_{nR,m}(z) represent the subband-domain filter structures for subband m of channel n, and whose outputs are combined to form the L-channel and R-channel output signals, respectively. The filtered subband signals for the L-channel output are combined and processed by the synthesis filterbank that generates the L-channel output signal. The filtered subband signals for the R-channel output are combined and processed by the synthesis filterbank that generates the R-channel output signal.

The subband-domain filter structure of the present invention may be used to implement other types of signal processing components in addition to HRTF, and it may be used in other applications in addition to binaural rendering. A few examples are mentioned above.

The following sections describe ways that may be used to design the amplitude, delay and phase filters. Other techniques may be used to design these filters if desired. No particular design technique is critical to the present invention. In addition, any or all of these filters can be implemented as part of another filter by including its response characteristics with that filter.

### 2. Amplitude Filter

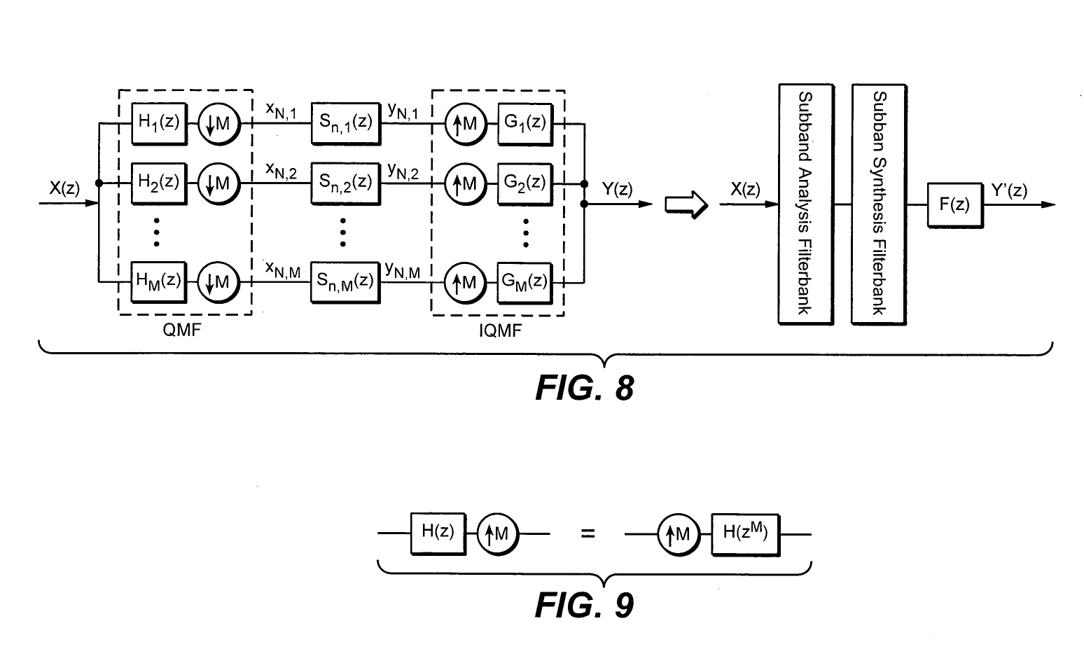

As explained above, the subband-domain filter structure is applied to a set of subband signals and provides its filtered output to the inputs of a synthesis filterbank as illustrated on the left-hand side of FIG. 8. The subband-domain structure is designed so that the output of the subsequent synthesis filterbank is substantially identical to the output obtained from a target time-domain filter shown on the right-hand side of FIG. 8. This time-domain filter is coupled to the output of a synthesis filterbank.

The output Y(z) of the system shown on the left-hand side of FIG. 8 can be expressed as:

$$Y ( z ) = \frac{1}{M} {x}^{T} ( z ) {H}_{AC} ( z ) g ( z ) \qquad ( 1 )$$

where M=total number of subbands;

X(z)=input signal to the analysis filterbank;

Hₖ(z)=impulse response of the analysis filterbank for subband k;

Gₖ(z)=impulse response of the synthesis filterbank for subband k;

$$\begin{matrix}{x}^{T} ( z ) = [ X ( z ) , X ( zW ) , … , X ( {zW}^{M - 1} ) ] ; & ( 2 ) \\ {H}_{AC} ( z ) = [ \begin{matrix}{H}_{1} ( z ) & … & {H}_{M} ( z ) \\ {H}_{1} ( zW ) & … & {H}_{M} ( zW ) \\ ⋮ & ⋰ & ⋮ \\ {H}_{1} ( {zW}^{M - 1} ) & … & {H}_{M} ( {zW}^{M - 1} )\end{matrix} ] ; & ( 3 ) \\ {g}^{T} ( z ) = [ {G}_{1} ( z ) \cdot {S}_{1} ( {z}^{M} ) , … {G}_{M} ( z ) \cdot {S}_{M} ( {z}^{M} ) ] ; and \\ W = {ⅇ}^{i \frac{π}{M}} . & ( 4 )\end{matrix}$$

The term z^{M} shown in expression 4 follows from the noble identities for a multirate system as shown in FIG. 9.

To simplify subsequent derivations, it is assumed that the analysis filterbank either is a complex oversampling filterbank like those used in HE-AAC or MPEG Surround coding systems (see Herre et al, “The Reference Model Architecture for MPEG Spatial Audio Coding,” AES Convention paper preprint 6447, 118th Convention, May 2005) or it implements an anti-aliasing technique (see Shimada et al., “A Low Power SBR Algorithm for the MPEG-4 Audio Standard and its DSP Implementation,” AES Convention preprint 6048, 116th Convention, May 2004) so that its aliasing term in H_{AC}(z)·g(z) is negligible. With this assumption:

$$\begin{matrix}{H}_{AC} ( z ) \cdot g ( z ) = {[ T ( z ) , 0 , … , 0 ]}^{T} \\ where & ( 5 ) \\ T ( z ) = {\sum }_{k = 1}^{M} {H}_{k } ( z ) {S}_{k} ( {z}^{M} ) {G}_{k} ( z ) . & ( 6 )\end{matrix}$$

Using expressions 5 and 6, expression 1 can be rewritten as:

$$Y ( z ) = {\sum }_{k = 1}^{M} {H}_{k} ( z ) {S}_{k} ( {z}^{M} ) {G}_{k} ( z ) X ( z ) . \qquad ( 7 )$$

The output Y′(z) of the system shown on the right-hand side of FIG. 8 can be expressed as:

$${Y}^{′} ( z ) = {\sum }_{k = 1}^{M} {H}_{k} ( z ) {G}_{k} ( z ) F ( z ) X ( z ) \qquad ( 8 )$$

where F(z)=the target time-domain filter.

If the two systems shown in FIG. 8 provide equal results, then Y(z)=Y′(z) and from expressions 7 and 8

$$\begin{matrix}{\sum }_{k = 1}^{M} {H}_{k} ( z ) {S}_{k} ( {z}^{M} ) {G}_{k} ( z ) = {T}^{′} ( z ) \\ where & ( 9 ) \\ {T}^{′} ( z ) = {\sum }_{k = 1}^{M} {H}_{k} ( z ) {G}_{k} ( z ) F ( z ) & ( 10 )\end{matrix}$$

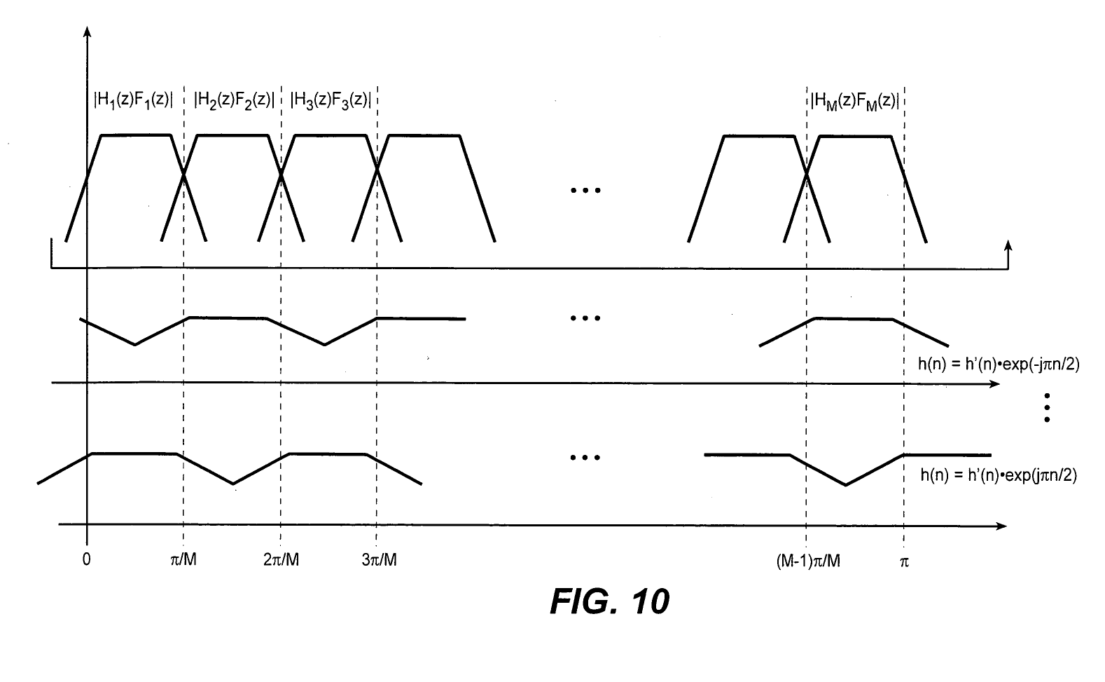

To simplify subsequent derivations, the only elements in expression 9 that are considered further are the ones that have significant energy. Referring to FIG. 10, for a well-designed filterbank, only subbands k and k+1 have significant energy at frequencies ω near subband boundaries

$$ω = \frac{k π}{M} \pm Δ ω , k = 1 , … M - 1$$

$$where \frac{k π}{M} = the subband boundary ; and$$

$$Δ ω ∈ [ 0 , \frac{π}{2 M} )$$

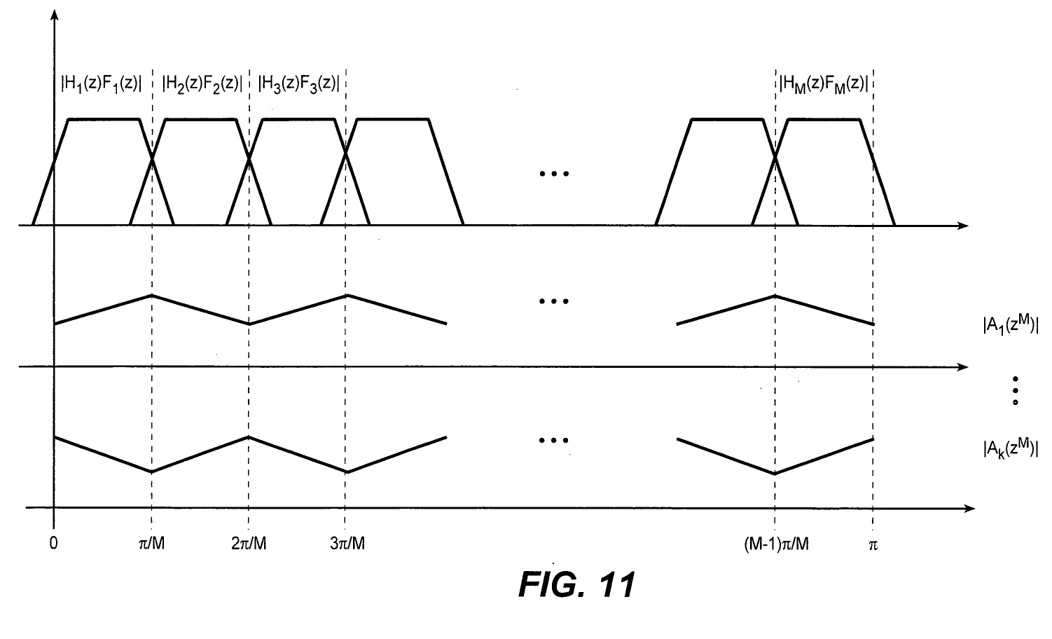

As a result, expression 9 can be simplified to the following:
Hₖ(ω)Sₖ(Mω)Gₖ(ω)+Hₖ₊₁(ω)Sₖ₊₁(Mω)Gₖ₊₁(ω))=T′(ω) (12)
The frequency response of each subband-domain filter at frequency ω is obtained by the substitution z=e^{jω}. In addition, the phase filter Pₖ(z) is designed in such a way that the phase responses of the first and second terms in expression 12 are approximately equal. As a result, the composite amplitude response of these two filters is equal to the composite of their amplitude responses. The amplitude filter Aₖ(z) is also required to be a real-valued coefficient linear phase FIR filter. Using these requirements along with an observation that the amplitude response of the amplitude filter Aₖ(Z) is symmetric and having knowledge of the desired response of filter F(z), the system of equations shown below can be written for the amplitude response for a given frequency. Reference to FIG. 11 may help visualize the construction of these equations.

$$\begin{matrix}\vert {F}_{1} ( Δ ω ) {H}_{1} ( Δ ω ) \vert \vert {A}_{1} ( Δ ω ) \vert = \vert {T}^{′} ( Δ ω ) \vert \\ \{ \begin{matrix}\vert {F}_{ 2 k - 1} ( {W}_{ M}^{ 2 k - 1} - Δ ω ) {H}_{ 2 k - 1} ( {W}_{ M}^{ 2 K - 1} - Δ ω ) \vert \vert {A}_{ 2 k - 1} ( π - M Δ ω ) \vert + \\ \vert {F}_{ 2 k} ( {W}_{ M}^{ 2 k - 1} - Δ ω ) {H}_{ 2 k} ( {W}_{ M}^{ 2 K - 1} - Δ ω ) \vert \\ \vert {A}_{ 2 k} ( π - M Δ ω ) \vert = \vert {T}^{ ′} ( {W}_{ M}^{ 2 k - 1} - Δ ω ) \vert \\ \vert {F}_{ 2 k - 1} ( {W}_{ M}^{ 2 k - 1} + Δ ω ) {H}_{ 2 k - 1} ( {W}_{ M}^{ 2 K - 1} + Δ ω ) \vert \vert {A}_{ 2 k - 1} ( π - M Δ ω ) \vert + \\ \vert {F}_{ 2 k} ( {W}_{ M}^{ 2 k - 1} + Δ ω ) {H}_{ 2 k} ( {W}_{ M}^{ 2 K - 1} + Δ ω ) \vert \\ \vert {A}_{ 2 k} ( π - M Δ ω ) \vert = \vert {T}^{ ′} ( {W}_{ M}^{ 2 k - 1} + Δ ω ) \vert\end{matrix} & ( 13 ) \\ for k = 1 , 2 , … , \frac{M}{ 2} \\ \{ \begin{matrix}\vert {F}_{ 2 k} ( {W}_{ M}^{ 2 k} - Δ ω ) {H}_{ 2 k} ( {W}_{ M}^{ 2 k} - Δ ω ) \vert \vert {A}_{ 2 k} ( M Δ ω ) \vert + \\ \vert {F}_{ 2 k + 1} ( {W}_{ M}^{ 2 k} - Δ ω ) {H}_{ 2 k + 1} ( {W}_{ M}^{ 2 k} - Δ ω ) \vert \\ \vert {A}_{ 2 k + 1} ( M Δ ω ) \vert = \vert {T}^{ ′} ( {W}_{ M}^{ 2 k} - Δ ω ) \vert \\ \vert {F}_{ 2 k} ( {W}_{ M}^{ 2 k} + Δ ω ) {H}_{ 2 k} ( {W}_{ M}^{ 2 k} + Δ ω ) \vert \vert {A}_{ 2 k} ( M Δ ω ) \vert + \\ \vert {F}_{ 2 k + 1} ( {W}_{ M}^{ 2 k} + Δ ω ) {H}_{ 2 k + 1} ( {W}_{ M}^{ 2 k} + Δ ω ) \vert \\ \vert {A}_{ 2 k + 1} ( M Δ ω ) \vert = \vert {T}^{ ′} ( {W}_{ M}^{ 2 k} + Δ ω ) \vert\end{matrix} & ( 14 ) \\ for k = 1 , 2 , … \frac{M}{ 2} - 1 & ( 15 ) \\ \vert {F}_{ M} ( π - Δ ω ) {H}_{ M} ( π - Δ ω ) \vert \vert {A}_{ M} ( π - M Δ ω ) \vert = \vert {T}^{ ′} ( π - Δ ω ) \vert \\ where {W}_{ M}^{ k} {=}^{Δ} \frac{k π}{ M} . & ( 16 )\end{matrix}$$

By restricting Δω to a set of discrete values

$$\{ Δ {ω}_{i} ∈ [ 0 , \frac{π}{2 M} ) \} ,$$

the equations shown above can be solved to obtain the amplitude response |Aₖ(ω)| for ω=MΔωᵢ and ω=π−MΔωᵢ. This response can be used to design the amplitude filter Aₖ(Z) using techniques such as those described in Parks et al., Digital Filter Design, John Wiley & Sons, New York, 1987.

This design process can be summarized as follows: obtain the amplitude response |Aₖ(ω)| for k=1, . . . , M by solving expressions 13 to 16 and use this response to design a linear-phase FIR filter Aₖ(Z).

### 3. Delay Filter

A filter that provides a fractional-sample delay is used in preferred implementations because a fine control of group delay on a banded frequency basis is related to inter-channel phase differences (IPD), inter-channel time differences (ITD) and inter-channel coherence differences (ICC). All of these differences are important in producing accurate spatial effects. A fractional-sample delay is even more desirable in implementations that use multirate filterbanks and down-sampling because the subband-domain filter structure operates at decimated sampling rates having sampling periods that are even longer than the sampling interval for the original signal.

Preferably, the delay filter is designed to have an approximate linear phase across the entire bandwidth of the subband. As a result, the delay filter has an approximately constant group delay across the bandwidth of the subband. This significantly reduces group-delay distortion at subband boundaries. A preferred method for achieving this design is to avoid attempts to eliminate group-delay distortion and instead shift any distortion to frequencies outside the passband of the synthesis filter for the subband.

In implementations that down-sample the subband signals according to their bandwidth, the sampling rate FS_{subband} for each subband signal is

$${FS}_{subband} = \frac{1}{M} {FS}_{time}$$

where M=decimation factor for the subband; and

FSₜᵢₘₑ=sampling rate of the original input signal.

In theory an ideal fractional-sample delay (FD) filter that provides a constant fractional-sample delay for all frequencies requires an infinite impulse response. Unfortunately, this is not practical. Practical designs of FD filters usually employ real-valued all-pass FIR or IIR filters that provide an accurate fractional-sample delay over a certain frequency range [−ω, ω₀] where ω₀<π. There can be a large deviation in delay at frequencies near the Nyquist frequency ω=π. This generally is not a problem for full-bandwidth FD filters because the Nyquist frequency is usually very high and perceptually insignificant. Unfortunately, the Nyquist frequency for subband FD filters in the subband-domain filter structure will be mapped to frequencies at subband boundaries. These frequencies are much lower and generally are perceptually relevant. For this reason, conventional FD filters are not desirable.

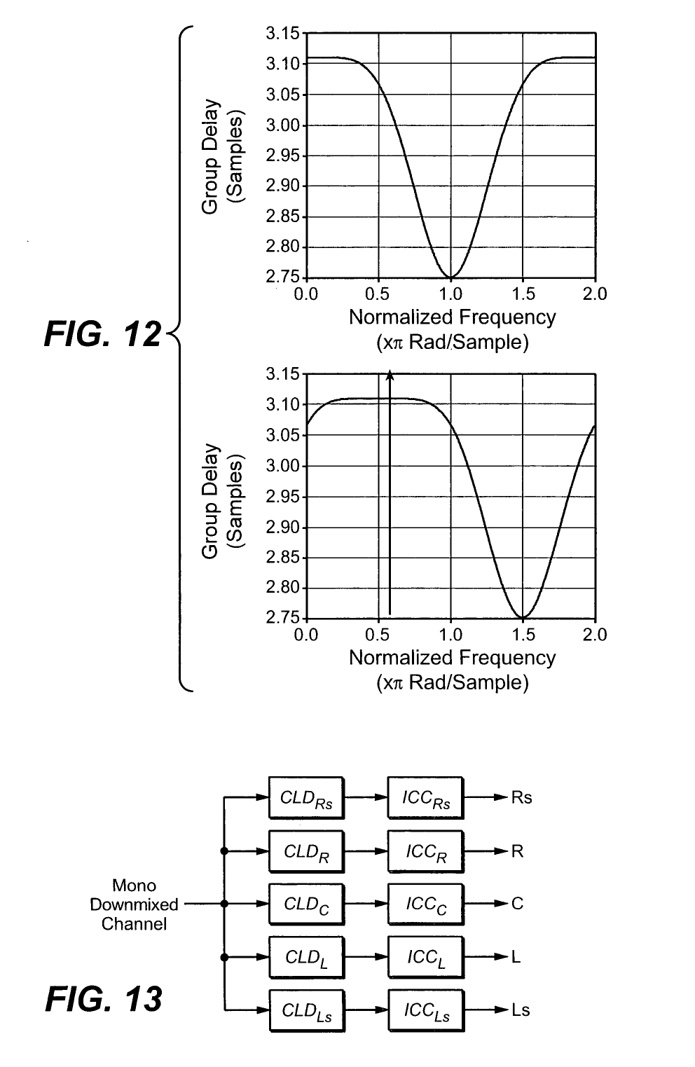

One way this problem can be avoided is to modulate the impulse response of a real-valued coefficient FD filter with a complex sinusoid signal to shift the constant-delay range of the filter so that it covers the desired frequency range after modulation. This is illustrated in FIG. 10 by an example. FIG. 12a illustrates the delay of a real-valued coefficient sixth-order FIR FD filter, which has an almost constant fractional-sample delay across the frequency range [−π/2,π/2). A large deviation from this delay occurs near the Nyquist frequency π. FIG. 12b illustrates the delay of the same filter but modulated by a complex sinusoid signal s(n)=e^{jnπ/2}. The resulting group delay is shifted by π/2, providing an almost constant fractional-sample delay across the frequency range [0,π).

Preferably, the FD filter should have a constant fractional-sample delay across the frequency range that has significant energy after subband synthesis filtering. As illustrated in FIG. 10 the constant fractional-sample delay for subband k should cover the frequency range [(k−1)π,kπ), which corresponds to the frequency range [0,π) in the decimated subband domain for k=1, 3, 5, . . . and corresponds to the frequency range [−π,0) in the decimated subband domain for k=2, 4, 6, . . . Consequently, the desirable FD filter can be obtained by modulating a prototype FD filter with a complex sinusoid having the frequency

$$ω = \frac{π}{2} or ω = - \frac{π}{2} .$$

This design process can be summarized as follows: design a prototype FD filter D′ₖ(z) with an impulse response h′ₖ(n), n=0, . . . , Lₖ−1, where Lₖ is the length of the filter, modulate the impulse response h′ₖ(n) by the complex sinusoid

$$s ( n ) = {ⅇ}^{i \frac{π}{2} n}$$

for odd values of k and by the complex sinusoid

$$s ( n ) = {ⅇ}^{- i \frac{π}{2} n}$$

for even values of k. The prototype FD filter can be obtained in a variety of ways disclosed in Laakso et. al., “Splitting the Unit Delay—Tools for Fractional Delay Filter Design,” IEEE Signal Processing Magazine, January 1996, pp. 30-60.

### 4. Phase Filter

The phase correction filter Pₖ(z)=e^{iφk} for each subband k is designed to ensure the overall phase response of the filter Hₖ(z)Sₖ(z)Gₖ(z) is aligned at frequencies

$$ω = \frac{k π}{M} k = 1 , … , M - 1 ,$$

on the boundaries between all subbands. By matching the phase responses between each adjacent subband filters, unintended signal cancellations in the synthesis filterbank can be avoided. In other words, a continuous phase response across subband boundaries ensures the subband filters will not generate a signal in one subband that incorrectly cancels or attenuates a signal generated in an adjacent subband. This may be accomplished by selecting the phase correction angle φₖ so that the phase response φₖ(ω) of the filter Hₖ(z)Sₖ(z)Gₖ(z) in subband k satisfies the equality

$${ϕ}_{k} ( \frac{k π}{M} ) = {ϕ}_{k + 1} ( \frac{k π}{M} ) for k = 1 , … , M - 1.$$

For many applications, other design considerations for the subband-domain filters Sₖ(z) yield similar amounts of delays at the boundaries between adjacent subbands. This condition is normally sufficient to ensure the phase response of the filters in adjacent subbands matches at the boundary between the subbands.

### C. Low Complexity Variations

The computational complexity of the technique used to implement the subband-domain filter structure can be reduced in several ways that are described below.

### 1. Subband Filter Order

The computational complexity of the filters used in some higher-frequency subbands can be reduced because of the coarser spectral detail of the target HRTF response in those subbands and because hearing acuity is diminished at the frequencies within those subbands.

It is well known that the human auditory system does not perceive sounds of different frequencies with equal sensitivity. The computational complexity of the subband-domain filters can be reduced whenever the resultant errors in the simulated HRTF are not discernable. For example, lower order amplitude filters Aₖ(z) may be used in higher-frequency subbands without degrading the perceived sound quality. Empirical tests have shown the amplitude response of many HRTF can be modeled satisfactorily with a zero-order FIR filter for subbands having frequencies above about 2 kHz. For these subbands, the amplitude filter Aₖ(Z) may be implemented as a single scale factor. The computational complexity of the delay filter Dₖ(z) can also be reduced in higher-frequency subbands by using integer-sample delay filters. Fractional-sample delays can be replaced with an integer-sample delay for subbands with frequencies above about 1.5 kHz because the human auditory system is insensitive to ITD at higher frequencies. Integer-sample delay filters are much less expensive to implement than FD filters.

### 2. Combine Coding Processes

The computational complexity of the process used to apply spatial side information in an audio decoder as shown in FIG. 3 can be reduced by combining and simplifying the two processes used to perform spatial audio decoding and binaural rendering.

As described above, typical side information parameters include channel level differences (CLD), inter-channel time differences (ITD) or inter-channel phase differences (IPD), and inter-channel coherence (ICC). In practice, the CLD and ICC are more important in recreating an accurate spatial image of an original multichannel audio program.

If only the CLD and ICC parameters are used, the Apply Spatial Side Information block shown in FIG. 3 can be implemented as shown in FIG. 13. In this example, an original multichannel audio program has been down-mixed to a single-channel signal. The blocks with labels CLD represent processes that obtain the proper signal amplitudes of each output-channel signal and the blocks with labels ICC represent processes that obtain the proper amount of decorrelation between the output-channel signals. Each CLD block process may be implemented by a gain applied to the entire wideband single-channel signal or it can be implemented by a set of different gains applied to subbands of the single-channel signal. Each ICC block process may be implemented by an all-pass filter applied to the wideband single-channel signal or it can be implemented by a set of different all-pass filters applied to a subband of the single-channel signal.

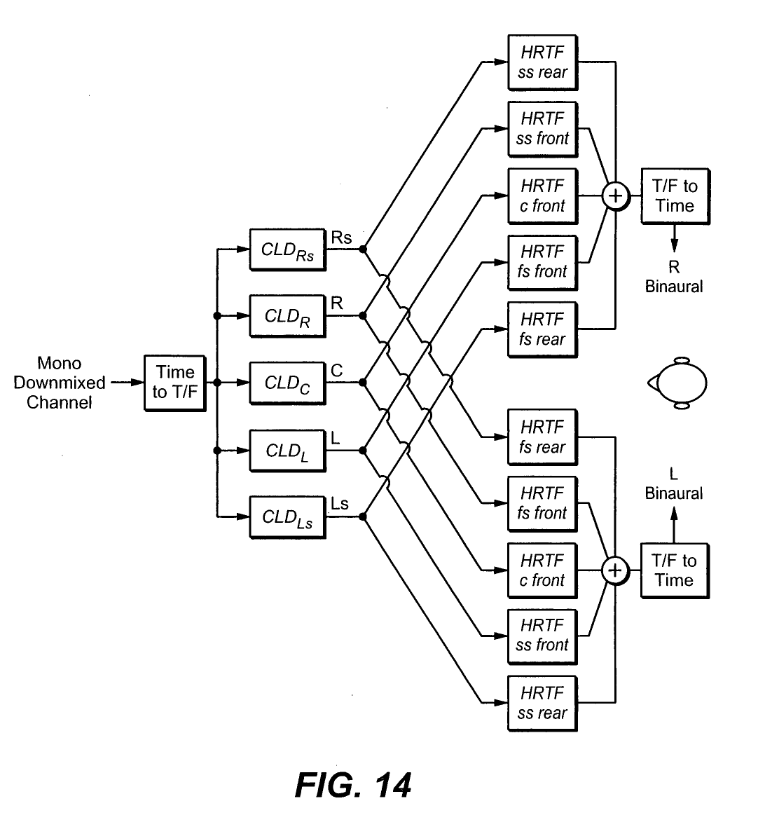

If desired, the computational complexity of the decoding and binaural rendering processes may be reduced further in exchange for a further degradation in output-signal quality by using only the CLD block processes. FIG. 14 illustrates how this simplified process can be incorporated into the system illustrated in FIG. 3. The signals for the Rs, R, C, L and Ls (right surround, right, center, left and left surround) channels differ with one another only in amplitude.

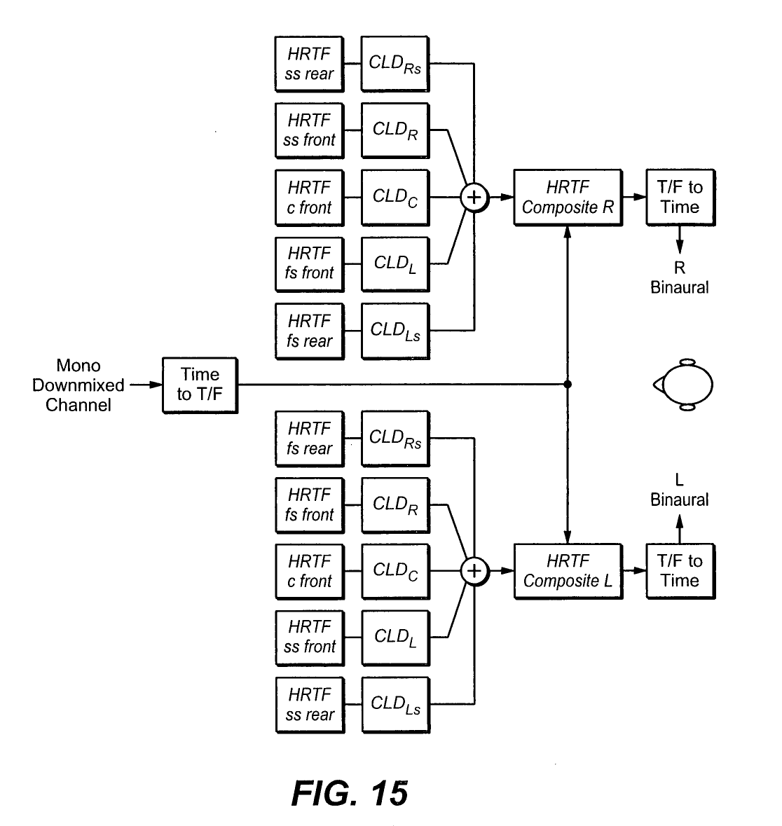

The structure of the processing components as shown in FIG. 14 may be rearranged as shown in FIG. 15 without affecting the accuracy of the results because all of the processes are linear. As shown, the process used to implement the filter structure for each individual HRTF shown in FIG. 14 is modified by either a wideband gain factor or by a set of subband gain factors and then combined to form a filter structure as shown in FIG. 15 that implements a composite HRTF for each output channel. In some applications, the CLD gain factors are conveyed with the encoded signal and are modified periodically. In this type of application, new filter structures for different composite HRTF are formed with each change gain factor.

This approach can reduce the computational complexity of the decoding processes because the amount of computational resources that are needed to form the subband-domain filter structures for the composite HRTF and then apply the filters for these composite HRTF is much less than the amount of computational resources that are needed to apply the filter structures for the individual HRTF shown in FIG. 14. This reduction in computational complexity should be balanced against a reduction in the quality of the binaural rendering. The principal cause for the reduction in quality is the omission of the processes needed to decorrelate signals according to the ICC parameters.

### 3. Combine Filters

The computational complexity of the filters for two or more subbands can be reduced if the filters for those subbands have any common component filters Aₖ(z), Dₖ(z) or Pₖ(Z). Common component filters can be implemented by combining the signals in those subbands and applying the common component filter only once.

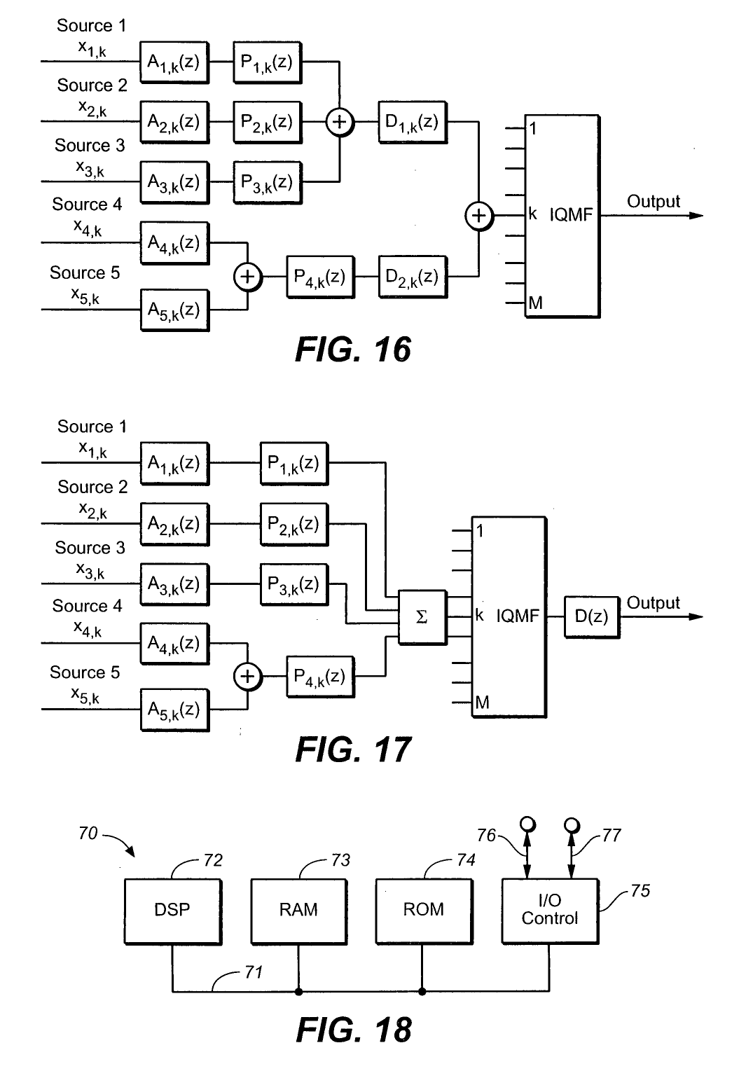

An example is shown in FIG. 16 for binaural rendering. In this example, the HRTF for acoustic sources 1, 2, 3 have substantially the same delay filter Dₖ(z) in subband k, and the HRTF for acoustic sources 4 and 5 have substantially the same delay filter Dₖ(z) as well as substantially the same phase filter Pₖ(z) in subband k. The delay filters for the HRTF of sources 1, 2 and 3 in subband k are implemented by down-mixing the subband signals and applying one delay filter Dₖ(Z) to the down-mixed signal. The delay and phase filters for the HRTF of sources 4 and 5 in subband k are implemented by down-mixing the subband signals and applying one phase filter Pₖ(z) and one delay filter Dₖ(Z) to the down-mixed signal. The down-mixed and filtered subband signals are combined and input to the synthesis filterbank as discussed above.

If a component filter is common to all subbands and all channels or sources, the common filter can be implemented in the time domain and applied to the output of the synthesis filter as shown in the example illustrated in FIG. 17. If the common filter is a delay filter, computation complexity can be reduced further by designing the filter to provide integer-sample delays.

### D. Implementation

Devices that incorporate various aspects of the present invention may be implemented in a variety of ways including software for execution by a computer or some other device that includes more specialized components such as digital signal processor (DSP) circuitry coupled to components similar to those found in a general-purpose computer. FIG. 18 is a schematic block diagram of a device 70 that may be used to implement aspects of the present invention. The DSP 72 provides computing resources. RAM 73 is system random access memory (RAM) used by the DSP 72 for processing. ROM 74 represents some form of persistent storage such as read only memory (ROM) for storing programs needed to operate the device 70 and possibly for carrying out various aspects of the present invention. I/O control 75 represents interface circuitry to receive and transmit signals by way of the communication channels 76, 77. In the embodiment shown, all major system components connect to the bus 71, which may represent more than one physical or logical bus; however, a bus architecture is not required to implement the present invention.

In embodiments implemented by a general purpose computer system, additional components may be included for interfacing to devices such as a keyboard or mouse and a display, and for controlling a storage device 78 having a storage medium such as magnetic tape or disk, or an optical medium. The storage medium may be used to record programs of instructions for operating systems, utilities and applications, and may include programs that implement various aspects of the present invention.

The functions required to practice various aspects of the present invention can be performed by components that are implemented in a wide variety of ways including discrete logic components, integrated circuits, one or more ASICs and/or program-controlled processors. The manner in which these components are implemented is not important to the present invention.

Software implementations of the present invention may be conveyed by a variety of machine readable media such as baseband or modulated communication paths throughout the spectrum including from supersonic to ultraviolet frequencies, or storage media that convey information using essentially any recording technology including magnetic tape, cards or disk, optical cards or disc, and detectable markings on media including paper.

1. A method for processing input information representing an input signal, wherein the method comprises:
receiving the input information and obtaining therefrom a plurality of subband signals of the input signal and subband gain factors;
obtaining modified filters by modifying a plurality of filters by the subband gain factors;
combining the modified filters to form a composite filter structure comprising delay and phase-correction filters;
generating respective filtered signals by applying the filters having amplitude responses that vary with frequency to the corresponding subband signals so that respective filtered signal amplitudes are altered with respect to corresponding subband signal amplitudes and by applying the delay and phase-correction filters to corresponding subband signals, wherein
each respective filtered signal is delayed in time and modified in phase with respect to its corresponding subband signal,
at least some of the delay filters are fractional-sample delay filters that are obtained by modulating the impulse response of a prototype fractional-sample delay filter having real-valued coefficients with a complex sinusoid,
a respective delay filter is implemented by finite impulse response (FIR) filter with a group delay that deviates from a constant value across a frequency range that includes the bandwidth of a respective subband signal filtered by the respective delay filter, the amount of deviation within the bandwidth of the respective subband signal being less than the amount of deviation outside this bandwidth, and
two or more of the respective filtered signals are delayed in time or modified in phase by a common filter; and
generating an output signal by applying a synthesis filterbank to the filtered signals, wherein the synthesis filterbank is a multirate filterbank.
